(19) United States
(12) Patent Application Publication
(10) Pub. No.: US 2010/0230907 A1
(43) Pub. Date: Sep. 16, 2010

(54) ACTUATOR

(76) Inventors: Kenta Hatano, Tokyo (JP); Hirofumi Doi, Tokyo (JP); Toshihiko Miyake, Tokyo (JP)

Correspondence Address: BIRCH STEWART KOLASCH & BIRCH, PO BOX 747, FALLS CHURCH, VA, 22040-0747, US

(21) Appl. No.: 12/305,924

(22) PCT Filed: Apr. 19, 2007
(86) PCT No.: PCT/JP2007/058530

§ 371 Date: Dec. 19, 2008

(30) Foreign Application Priority Data
Sep. 15, 2006 (JP) 2006-251359

(51) Int. Cl. F16J 15/52

(52) U.S. Cl. 277/634

(57) ABSTRACT

An actuator equipped with a boot for preventing an intruder from intruding into the actuator by way of an output axis's surface includes a plate formed in a cylindrical shape, having an end in which a flange to which an end portion of the above-mentioned boot is locked is formed and being fitted to the above-mentioned output axis, and a projection formed on an outer surface of the above-mentioned output axis in such away as to lock the above-mentioned plate. A breathing hole for communicating the interior of the above-mentioned boot with the exterior of the above-mentioned boot is disposed between the above-mentioned output axis and the above-mentioned plate.

### FIELD OF THE INVENTION

The present invention relates to an actuator equipped with a boot for preventing an intruder from intruding thereinto by way of an output axis's surface.

### BACKGROUND OF THE INVENTION

As a conventional actuator equipped with a boot, there has been provided an actuator in which the above-mentioned boot has an end which is locked by a groove formed in a casing of the above-mentioned actuator, and another end which is locked by a groove formed in an outer surface of an output axis as mentioned above, and a breathing hole is formed in the above-mentioned casing for communicating the interior of the actuator with the exterior of the actuator in order to prevent a differential pressure from occurring between the interior of the actuator and the exterior of the actuator due to variations in the volumetric capacity of the interior of the actuator which are caused by movements of the above-mentioned output axis (for example, refer to patent reference 1).
[Patent reference 1] JP, 3-29708,U

Because the conventional actuator is constructed as mentioned above and the other end of the boot is locked by the groove which is formed in the outer surface of the output axis along a direction perpendicular to the length of the output axis, a problem with the conventional actuator is that the cross-sectional area of a portion of the output axis in which the groove is formed is small, and therefore the mechanical strength of the output axis is reduced. While the mechanical strength of the output axis is ensured in a case in which the outer diameter of the above-mentioned portion of the output axis in which the groove is formed is made thick in order to ensure the mechanical strength of the output axis, it is necessary to provide a material having the same outer diameter as this portion whose thickness is increased for the output axis, and to scrape off an excessive portion of the material. Another problem is therefore that many useless portions occur in the output axis, and therefore the manufacturing process becomes complicated and the manufacturing cost increases.

The present invention is made in order to solve the above-mentioned problems, and it is therefore an object of the present invention to provide an actuator which can lock a boot to an output axis without impairing the mechanical strength of the above-mentioned output axis.

### DISCLOSURE OF THE INVENTION

In accordance with the present invention, there is provided an actuator including a plate formed in a cylindrical shape, having an end in which a flange to which an end portion of a boot is locked is formed and being fitted to an output axis, and a projection formed on an outer surface of the above-mentioned output axis in such a way as to lock the above-mentioned plate, wherein a breathing hole for communicating the interior of the above-mentioned boot with the exterior of the above-mentioned boot is disposed between the above-mentioned output axis and the above-mentioned plate.

In accordance with the present invention, because the cylindrically-shaped plate in which the flange to which the end portion of the boot is locked is formed is fitted to the output axis, and the projection for locking the above-mentioned plate to the above-mentioned output axis is formed, the above-mentioned boot can be locked to the above-mentioned output axis without impairing the mechanical strength of the above-mentioned output axis. Furthermore, because the breathing hole for communicating the interior of the boot with the exterior of the boot is formed between the output axis and the plate, it is not necessary to dispose such a breathing hole in another part and there is provided, for example, an advantage of being able to eliminate the necessity to provide excessive space.

### BRIEF DESCRIPTION OF THE FIGURES

FIG. 1 is a partially sectional view of an actuator in accordance with Embodiment 1;

FIG. 2 is an enlarged view of a boot locking member in accordance with Embodiment 1;

FIG. 3 is an enlarged view of a boot locking member in accordance with Embodiment 2;

FIG. 4 is an enlarged view of a boot locking member in accordance with Embodiment 3; and

FIG. 5 is an enlarged view of a boot locking member in accordance with Embodiment 4.

### PREFERRED EMBODIMENTS OF THE INVENTION

Hereafter, in order to explain this invention in greater detail, the preferred embodiments of the present invention will be described with reference to the accompanying drawings.

### Embodiment 1

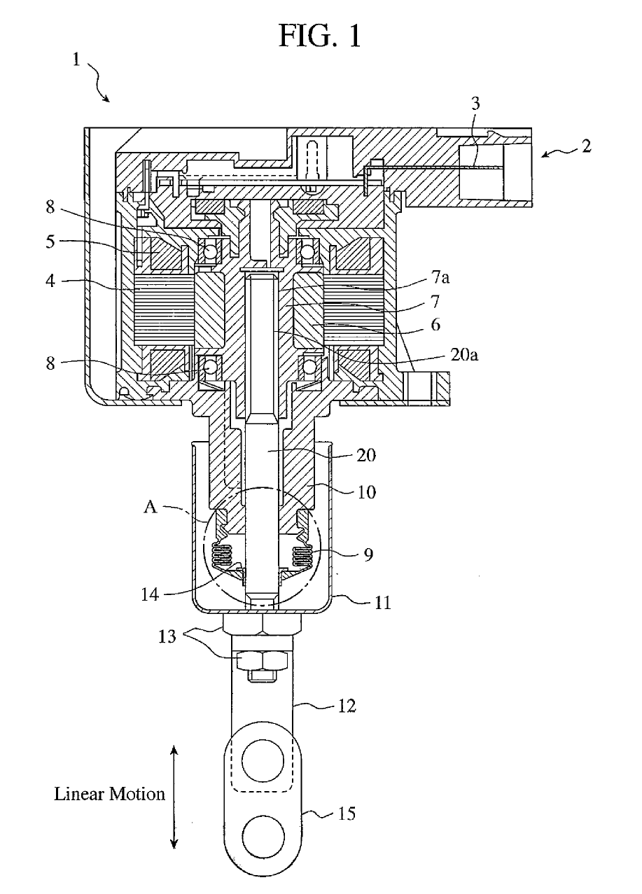

FIG. 1 is a partially sectional view showing an example of the structure of an actuator 1 in accordance with Embodiment 1 of the present invention. In this Embodiment 1, an actuator which uses an electromagnetic force (a motor) as a driving system for driving an output axis will be explained, though the present invention can also be applied to an actuator which uses another type of driving system, e.g., a driving system using air pressure, oil pressure, or an ultrasonic wave.

The actuator 1 is provided with an external I/O connector 2 for connecting the actuator to an external power supply for applying a voltage thereto, a terminal 3 for supplying the voltage applied to the external I/O connector 2 to the interior of the actuator, a coil 5 to which the voltage is applied, via the terminal 3, from the exterior of the actuator, a stator 4 around which the coil 5 is wound, a rotator 7 rotatably held by a bearing 8, an output axis 20 having a male screw portion 20a which is screwed into a female screw portion 7a formed in a central part of the rotator 7, a boss 10 for holding the output axis 20 in a state in which the output axis 20 is projecting in such a way that the output axis 20 can move linearly, a boot 9 for preventing an intruder, e.g., a foreign object, such as dust, or a fluid, such as water, from intruding into the interior of the actuator 1 from the gap between the output axis 20 and the boss 10, and a metallic plate 14 which is locked to an end of the boot 9 and is fitted to the output axis 20. Furthermore, a cover 11 and an end of a joint 12 are attached to a leading end of the output axis 20 using a nut 13, and another end of the joint 12 is connected to an external device by way of a link plate 15.

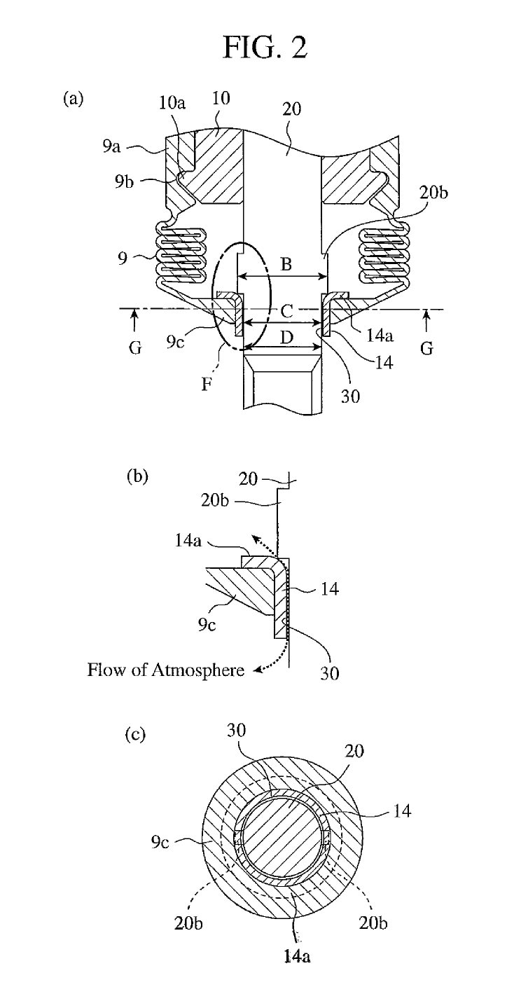

FIG. 2(a) is a cross-sectional view which enlargely shows a portion designated by A shown in FIG. 1 (a locking member of the boot 9). The boot 9 is made from an elastic body, such as a silicone rubber, which is formed in a cylindrical shape with a bellow structure. A groove 9b formed in the inner surface of an end 9a of the boot 9 is fitted to a projecting portion 10a formed in the outer surface of an end portion of the boss 10 in such a way that the boot is locked to the boss. Another end 9c of the boot 9 is locked to a flange 14a of the plate 14 which is fitted to the output axis 20 and which is formed in a cylindrical shape. This plate 14 has an inner diameter C larger than the outer diameter D of the output axis 20, and a breathing hole 30 for communicating the interior of the boot 9 with the exterior of the boot 9 is disposed between the inner surface of the plate 14 and the outer surface of the output axis 20. Two projecting portions 20b each of which is made to project and have a rectangular shape through forging machining are formed on the outer surface of the output axis 20 in such away that the distance B between the end surface of one of the two projecting portions 20b and the end surface of the other projecting portion 20b is greater than the inner diameter C of the plate 14. FIG. 2(b) is a figure which enlargely shows a portion designated by F shown in FIG. 2(a), and an arrow in the figure shows a flow of the atmosphere. FIG. 2(c) is a cross-sectional view taken along the G-G line shown in FIG. 2(a).

Next, the operation of the actuator will be explained.

When a voltage is applied from the not-shown exterior of the actuator to the coil 5 byway of the external I/O connector 2 and the terminal 3, an electromagnetic field is formed and the rotator 7 rotates. In this case, because the output axis 20 is connected to an external device, the output axis is prevented from rotating. Therefore, the interaction of the female screw portion 7a formed in the rotator 7 with the male screw portion 20a formed in the output axis 20 converts the rotation of the rotator 7 into linear motion of the output axis 20, so that the output axis 20 moves linearly in the axis direction to make the external device connected to the output axis 20 operate.

The plate 14 always receives a force in the direction toward the boss 10 due to the contracting of the boot 9 which is locked to the flange 14a. Furthermore, because the plate 14 is prevented from moving toward the boss 10 by the projecting portions 20b, the plate 14 is always locked to the projecting portions 20b in a state in which the plate is in contact with the projecting portions 20b formed on the output axis 20. As a result, the boot 9 also expands and contracts according to the linear motion of the output axis 20 and the gap between the output axis 20 and the boss 10 is always covered by the boot 9, so that an intruder, such as dust or a fluid, can be prevented from intruding into the interior of the actuator 1 from the gap between the output axis 20 and the boss 10.

In this Embodiment 1, the two projecting portions 20b are formed. As an alternative, one or more projecting portions 20b can be formed. Furthermore, the shape of each projecting portion 20b is not restricted to a rectangular one. In addition, in order to prevent the rotary motion of the output axis 20, a flat portion (a so-called D cut) can be formed in a part of the output axis 20 along the length of the output axis, and the shape of the hole of the boss 10 into which the output axis 20 is inserted can have the same shape as the radial cross section of the output axis 20. Furthermore, in order to reduce the manufacturing cost, the plate 14 can be made from a resin.

As mentioned above, the actuator 1 in accordance with Embodiment 1 is constructed in such a way that the plate 14 formed in a cylindrical shape and having an end in which the flange 14a to which an end portion of the boot 9 is locked is formed is fitted to the output axis 20, and the projecting portions 20b for locking the plate 14 are formed on the outer surface of the output axis 20. Therefore, it is not necessary to form a groove for locking the plate 14 in the output axis 20, and the boot 9 can be locked without impairing the mechanical strength of the output axis 20. There is provided another advantage of being able to eliminate the necessity to increase the outer diameter of the output axis 20 in order to ensure the mechanical strength of the output axis 20, thereby reducing the outer diameter of the output axis 20 and hence reducing the cost of the material required to produce the output axis. In addition, because the projecting portions 20b are formed on the output axis 20 through forging machining, and the plate 14 separately formed is simply fitted to the output axis 20, there is provided a further advantage of being able to simplify the manufacturing process and hence reduce the manufacturing cost. Furthermore, because the atmosphere contained in the boot 9 moves via the breathing hole 30 when the output axis 20 is made to operate, there is provided another advantage of being able to prevent fluctuations of the pressure of the atmosphere contained in the boot 9, and make the output axis 20 linearly move smoothly.

### Embodiment 2

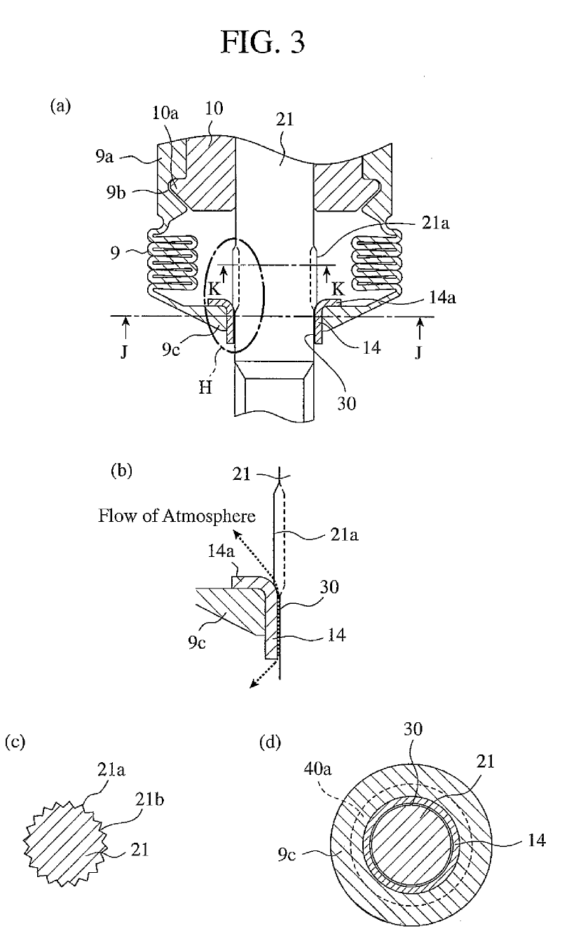

FIG. 3 is a view showing a boot locking member in accordance with Embodiment 2, and an explanation of the boot locking member will be made with the same components as those shown in FIG. 2 being designated by the same reference numerals as those shown in the figure. FIG. 3(a) is an enlarged view of the boot locking member in accordance with Embodiment 2. FIG. 3(b) is an enlarged view of a portion designated by H shown in FIG. 3(a), and an arrow in the view shows a flow of atmosphere. FIG. 3(c) is a cross-sectional view taken along the K-K line shown in FIG. 3(a). FIG. 3(d) is a cross-sectional view taken along the J-J line shown in FIG. 3(a). In this Embodiment 2, through knurling machining, as shown in FIGS. 3(a) to 3(c), projecting and recessed portions 21b and 21a are formed in a part with respect to an axis direction of the outer surface of an output axis 21 in such a way that the projecting and recessed portions are arranged throughout the entire perimeter of the output axis along the direction of the diameter of the output axis.

In this Embodiment 2, because the projecting portions 21a are formed through knurling machining, the plate 14 fitted to the output axis 21 is locked by these projecting portions 21a. Each recessed portion 21b which is a breathing hole which communicates the interior of the boot 9 with the exterior of the boot 9 is formed between these two adjacent projecting portions 21a. Therefore, the atmosphere contained in the boot 9 moves via the breathing hole 30 and the recessed portions 21b, as shown by the arrow in FIG. 3(b). The projecting portions 21a can be formed in the outer surface of the output axis 21 partially with respect to the direction of the diameter of the output axis. The other advantages provided by the present embodiment are the same as those of Embodiment 1.

### Embodiment 3

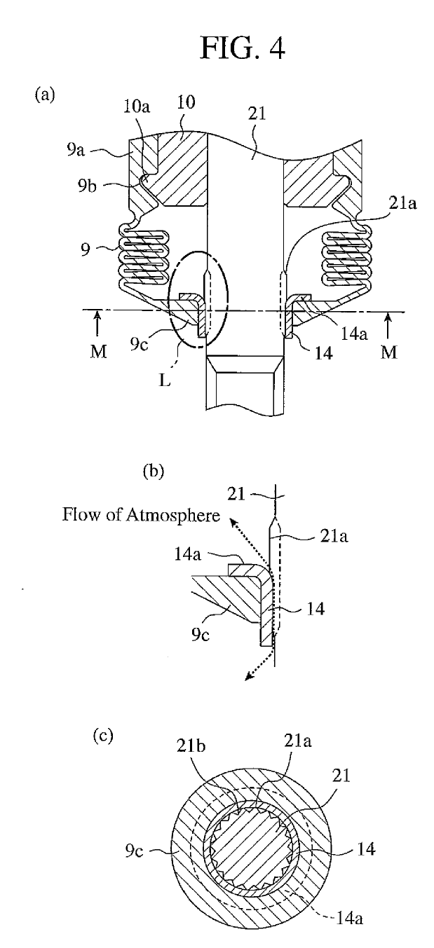

FIG. 4 is a view showing a boot locking member in accordance with Embodiment 3, and an explanation of the boot locking member will be made with the same components as those shown in FIG. 3 being designated by the same reference numerals as those shown in the figure. FIG. 4(a) is an enlarged view of the boot locking member in accordance with Embodiment 3. FIG. 4(b) is an enlarged view of a portion designated by L shown in FIG. 4(a), and an arrow in the view shows a flow of atmosphere. FIG. 4(c) is a cross-sectional view taken along the M-M line shown in FIG. 4(a). In accordance with this Embodiment 3, the plate 14 is press-fitted to the projecting and recessed portions 21b and 21a formed in the outer surface of the output axis 21 through knurling machining. In this case, if the plate 14 is made from metal, the reliability (endurance) of the plate as holding structure for the knurled portion is improved. Because the plate 14 is thus press-fitted to the output axis 21, the projecting and recessed portions 21b and 21a can be alternatively formed in the inner surface of the plate 14. As an alternative, only the projecting portions 21a or the recessed portions 21b can be formed. In a case in which only the recessed portions 21b are formed, it is necessary to make the inner diameter of the plate 14 smaller than the outer diameter of the output axis 21.

In accordance with this Embodiment 3, because the plate 14 is surely fixed to the output axis 21 through press fitting, any rattle does not occur in the plate 14 due to external factors, such as vibration, and occurrence of wear due to rattles can be prevented. Therefore, the present embodiment offers an advantage of being able to improve the reliability of the actuator 1. Furthermore, because the plate is fixed to the output axis through press fitting, there is provided another advantage of being able to construct the actuator by using a simple method of assembling the actuator. The other advantages provided by the present embodiment are the same as those of Embodiment 2.

### Embodiment 4

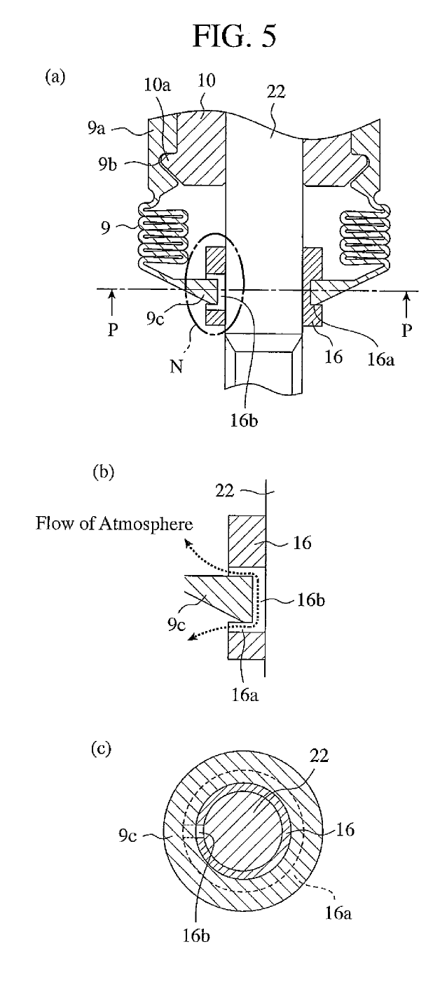

FIG. 5 is a view showing a boot locking member in accordance with Embodiment 4, and an explanation of the boot locking member will be made with the same components as those shown in FIG. 2 being designated by the same reference numerals as those shown in the figure. FIG. 5(a) is an enlarged view of the boot locking member in accordance with Embodiment 4. In accordance with this Embodiment 4, through resin insert molding, a projecting portion 16 having a cylindrical shape in which a groove 16a is formed in the outer surface thereof is formed on the outer surface of an output axis 22, and the end portion 9c of the boot 9 is locked to the groove 16a. FIG. 5(b) is an enlarged view of a portion designated by N shown in FIG. 5(a). In a part of the projecting portion 16, a breathing hole 16b for communicating the interior of the boot 9 with the exterior of the boot 9 is disposed between the boot 9 and the output axis 22. Two or more breathing holes 16b can be formed. The atmosphere contained in the boot 9 moves via this breathing hole 16b. An arrow shown in the view shows a flow of atmosphere. FIG. 5(c) is a cross-sectional view taken along the P-P line shown in FIG. 5(a). In this case, the projecting portion 16 has only to lock the end portion 9c of the boot 9. For example, the projecting portion 16 can be formed on the output axis 22 in such a way that the projecting portion 16 has the same cylindrical shape as the plate 14 and has a flange at an end thereof, and the breathing hole 16b for communicating the interior of the boot 9 with the exterior of the boot 9 can be disposed between the boot 9 and the output axis 22

In accordance with this Embodiment 4, through resin insert molding, the projecting portion 16 having the groove 16a for locking the end portion 9c of the boot 9 and the breathing hole 16b for communicating the interior of the boot 9 with the exterior of the boot 9 is formed. Therefore, the present embodiment offers an advantage of being able to simplify the machining and hence reduce the cost of the machining. The other advantages provided by the present embodiment are the same as those of Embodiment 3.

### INDUSTRIAL APPLICABILITY

As mentioned above, because the actuator in accordance with the present invention can lock the boot to the output axis without impairing the mechanical strength of the above-mentioned output axis, the actuator in accordance with the present invention is suitable for use in a location where dust resistance and a driving force are required.

1. An actuator equipped with a boot for preventing an intruder from intruding into said actuator by way of an output axis's surface, said actuator comprising:
a plate formed in a cylindrical shape, having an end in which a flange to which an end portion of said boot is locked is formed and being fitted to said output axis; and
a projection formed on an outer surface of said output axis in such a way as to lock said plate, wherein a breathing hole for communicating an interior of said boot with an exterior of said boot is disposed between said output axis and said plate.

2. The actuator according to claim 1, wherein said projection is formed through forging machining.

3. The actuator according to claim 1, wherein said projection is formed through knurling machining.

4. The actuator according to claim 1, wherein a projection for locking the end portion of said boot is formed through resin insert molding, and a breathing hole for communicating the interior of said boot and the exterior of said boot is disposed between said boot and said output axis.

5. An actuator equipped with a boot for preventing an intruder from intruding into said actuator by way of an output axis's surface, said actuator comprising:
a plate formed in a cylindrical shape, having an end in which a flange to which an end portion of said boot is locked is formed and being press-fitted into said output axis, wherein either of a projecting portion, a dented portion, and projecting and dented portions are formed along an axial direction in either or both of an inner surface of said plate and an outer surface of said output axis.
